(19) United States
(12) Patent Application Publication
(10) Pub. No.: US 2022/0262267 A1
(43) Pub. Date: Aug. 18, 2022

(54) SYSTEM AND METHOD FOR AUTOMATED GENERATION OF STUDY CARDS

(71) Applicant: Toshiba TEC Kabushiki Kaisha, Shinagawa-ku (JP)

(72) Inventor: Jia ZHANG, Irvine, CA (US)

(21) Appl. No.: 17/174,599

(22) Filed: Feb. 12, 2021

(51) Int. Cl. G09B 5/02; G06F 40/171; G06F 40/106; G06K 9/00

(52) U.S. Cl. CPC G09B 5/02; G06K 9/00442; G06F 40/106; G06F 40/171

(57) ABSTRACT

A system and method for automated generation of study cards stores digital images of user highlighted content. A digital image is captured of highlighted print media by photo or scanning. Highlighted content from digitally displayed content is captured by electronic file or screenshot. Highlighted areas from captured content is determined and isolated, displayed for confirmation or correction, and labeled, organized stored or printed by the user.

### TECHNICAL FIELD

This application relates generally to automated generation of study aids from highlighted document portions.

### BACKGROUND

A study technique commonly employed by students, trainees or the like includes using a highlighter pen to highlight text or illustrations when reading a textbook. When a user wishes to refresh their recollection efficiently, such as to prepare for an exam or test, they can look at the book again and focus on the highlighted portions.

### BRIEF DESCRIPTION OF THE DRAWINGS

Various embodiments will become better understood with regard to the following description, appended claims and accompanying drawings wherein:

FIG. 1 is an example embodiment of an automated study card generation system;

FIG. 2 is an example embodiment of a networked digital device;

FIG. 3 is an example embodiment of a digital device system;

FIG. 4 is an example embodiment of automated generation of study cards;

FIG. 5 is a flowchart of an example embodiment of an automated study card generation system; and

FIG. 6 is an example embodiment of a software block diagram suitably implemented in connection with an automated study card generation system.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Certain embodiments disclosed herein include document processing devices. Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

In example embodiments herein, a user highlights a document and a system is provided to manage highlighted areas freeing the user from having to go back to the physical, previously highlighted books. Documents may comprise any suitable medium of expression, such as textbooks, magazines, brochures, pamphlets, treatises or the like. As used herein, book is to be understood of including any such document.

When highlighted book portions are to be reviewed, entire books must be stored, carried or retrieved for reviewing. Books, along with highlighting, may include bookmarks for particularly relevant excerpts or to eliminate a need to go through every page to find previously defined highlighted area. Embodiments herein teach a system providing an easy way for a user to generate study cards and manage them systematically.

In embodiments as detailed below, while reading a physical or an electronic book, a user highlights areas of interest. A digitized image of highlighted book pages is obtained by either taking a picture of or scanning each page of the tangible book with one or more highlighted areas or taking a screen shot of pages with one or more highlighted areas of an electronic book. The captured images are displayed on any suitable digital user device, such as a display on a notebook or desktop computer, a tablet computer or a smartphone. The user selects from these images on their device. Example embodiments herein automatically recognize highlighted areas on each image and crop these areas and generate individual images for each highlighted area.

Additional example embodiments facilitate a user's merging of two or multiple auto-generated study cards into one image or an ability to split one study card into multiple smaller ones. The system allows a user to confirm and label generated study cards. Cards can be labeled individually or in two or more groups of images, suitably at the same time. Labels are suitably organized hierarchically. For example, a top level may be a broad category of “Math,” having sub-levels of geometry, trigonometry, algebra, calculus, etc.

In another example embodiment, a mobile application keeps a history of all previous added images, and appends newly generated images to the group. A user is able to delete existing images from a label group or change an image label group name.

In another example embodiment, when a user wishes to review their study cards, they open a mobile application and select a label from displayed label hierarchy.

In another example embodiment, a user highlights entries in a tangible document, such as a book. The user suitably takes pictures of pages with one or multiple highlighted areas. In other embodiments the user applies highlighting on their digital device while viewing a displayed electronic book. In this example embodiment, the user suitably takes a screen shot of a page with one or multiple highlighted areas. An application on their mobile device automatically detects highlighted areas and crops each area into a different image.

Starting with either a tangible document or an electronic document, a user is able to review automatically generated images and merge two or more images into one image or split one image into smaller images. After confirming correctness of displayed images, the user can label each image or label a group of images at one time. This is suitably accomplished by user selection from a dropdown label list or creation of a new label.

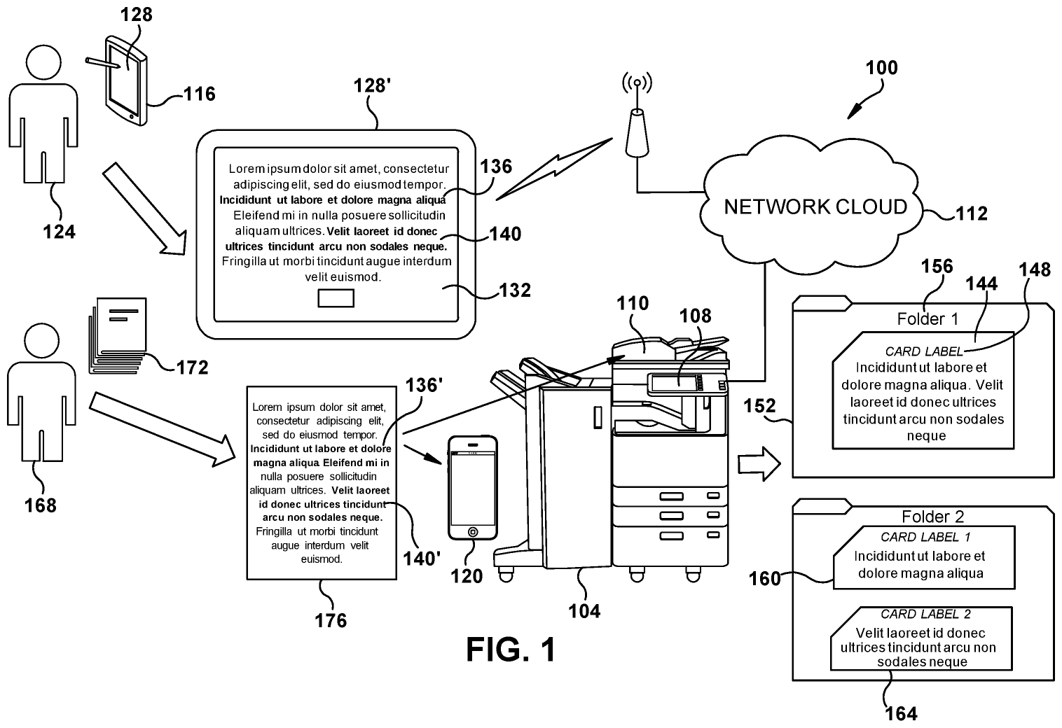

In accordance with the subject application, FIG. 1 illustrates an example embodiment of an automated study card generation system 100 that includes one or more MFPs, illustrated by way of example by MFP 104. MFP 104 includes a user interface 108 suitably comprised of touchscreen and scanner interface 110. MFP 104 is in network communication with network cloud 112, suitably comprised of any wireless or wired local area network (LAN) or a wide area network (WAN) which can comprise the Internet, or any suitable combination thereof. Also in network communication are one or more digital devices including, for example tablet 116 and smartphone 120, both suitably including an integrated digital camera for image capture.

In the example embodiment of FIG. 1, tablet 116 is associated with user 124 and includes touchscreen display 128. An electronic document 132 is displayed on the touchscreen display 128 as illustrated by display 128′. In the illustrated example, user 124 has highlighted portions 136 and 140 of electronic document 132. User 124 suitably takes a screenshot of one or more pages with highlighted portions and sends them via network cloud 112 to a networked digital device, such as MFP 104, for processing. As will be detailed further below, MFP 104 extracts highlighted portions 136 and 140 from a received screen capture to form a foundation for generation of study cards. Extracted highlighted portions are displayed to user 124, suitably via tablet 116 or touchscreen of user interface 108 for confirmation and labeling. User 124 confirms and labels each capture, or capture group. In the illustrated example, a single study card 144 may be generated having both captured highlighted portions 136 and 140 combined. Study card 144, stored and displayable in electronic form, can suitably be printed to a tangible document via MFP 104. User 124 suitably selects a label 148 for study card 144, either by selecting from existing card label names or entering a desired card label name. User 124 also suitably associates study card 144 with a grouping of other study cards, such as by associating it with folder 152. User 124 may also supply a group or folder name 156 by selection of an earlier folder name or entering a desired folder name.

User 124 may, optionally or additionally, choose to store captured highlighted portions 136 and 140 in more than one study card. In the illustrated example, highlighted portion 136 is associated with study card 160 and highlighted portion 140 is associated with study card 164. A user suitably supplies card labels and/or folder labels assignments to cards, or groups of cards, as detailed above.

In another illustrated example embodiment, user 168 views tangible documents, such as books 172. The user physically highlights portions 136′ and 140′ on book page 176. A digital image of one or more pages with highlighted portions is captured, suitably by taking a picture with smartphone 120 or engaging the scanner interface 110 on MFP 104. Once digital images are obtained, generation, labeling, organization and printing are suitably accomplished as detailed above.

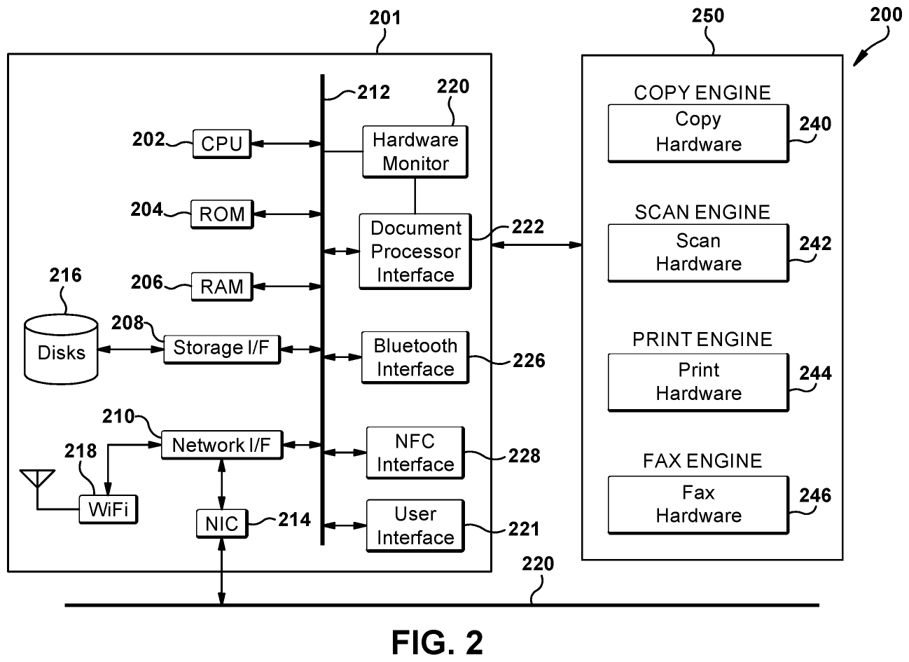

Turning now to FIG. 2, illustrated is an example embodiment of a networked digital device comprised of document rendering system 200 suitably comprised within an MFP, such as with MFP 104 of FIG. 1. It will be appreciated that an MFP includes an intelligent controller 201 which is itself a computer system. Thus, an MFP can itself function as a cloud server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless data connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with user interface 219 or interfacing with displays, keyboards, touchscreens, mice, trackballs and the like.

Processor 202 can also be in data communication with any suitable user input/output (I/O) interface 221 which provides data communication with user peripherals, such as displays, keyboards, mice, track balls, touch screens, or the like. Processor 202 is also in data communication hardware monitor 220, Bluetooth interface 226, NFC interface 228.

Also in data communication with data bus 212 is a document processor interface 222 suitable for data communication with the document rendering system 250, including MFP functional units. In the illustrated example, these functional units include copy hardware 240, scan hardware 242, print hardware 244 and fax hardware 246 which together comprise document rendering system 250. It will be understood that functional units are suitably comprised of intelligent units, including any suitable hardware or software platform.

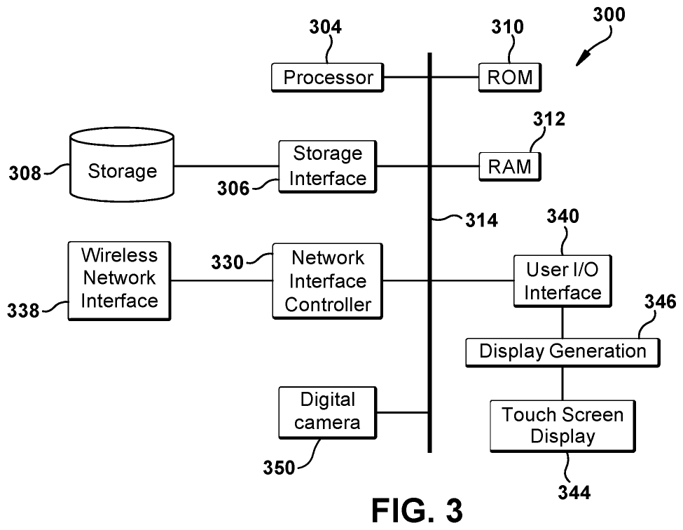

Turning now to FIG. 3, illustrated is an example embodiment of a digital data processing device 300 such as tablet 116 and smartphone 120 of FIG. 1. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. A network interface controller 330 suitably provides a gateway for data communication with other devices, such as via wireless network interface 338 A user input/output interface 340 suitably provides display generation 346 providing a user interface via touchscreen display 344, suitably comprised of a touch-screen display. Also in data communication with processor 304 is digital camera 350. It will be understood that the computational platform to realize the system as detailed further below is suitably implemented on any or all of devices as described above.

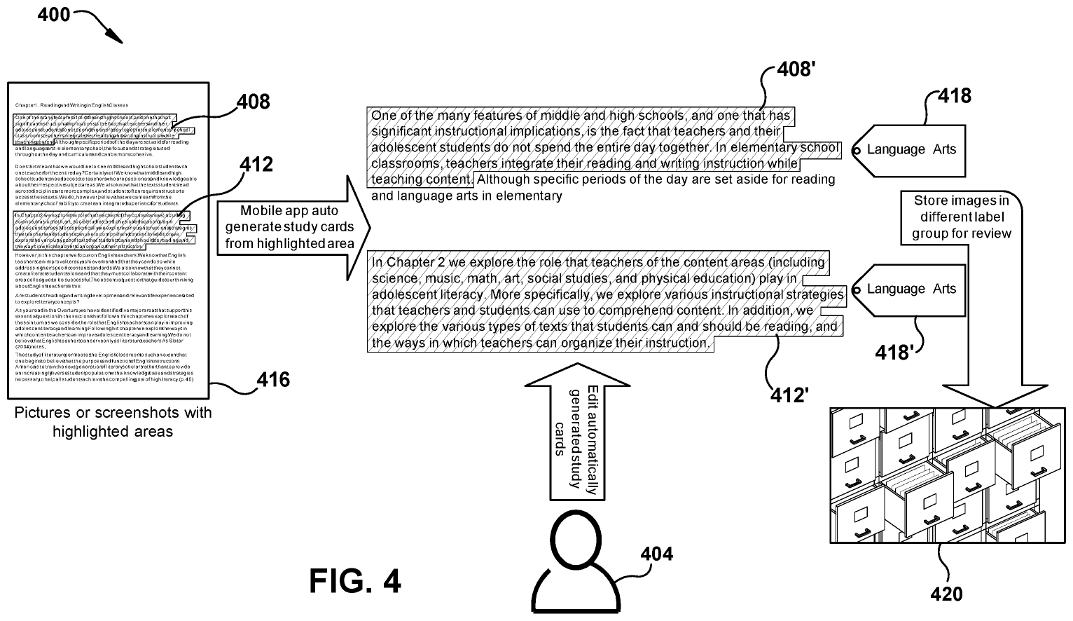

FIG. 4 illustrates an example embodiment of automated generation of study cards 400 for user 404. In the example, user 404 highlights text areas 408 and 412 from text page 416. Text page 416 is suitably a manually highlighted tangible page or electronically highlighted displayed page as detailed above. In the illustrated example, user 404 supplies label 418 “Language Arts” to text area 408. The same label is supplied to text area 412 as illustrated at 416′. Study cards a suitably stored in labeled folders or groups as illustrated at 420.

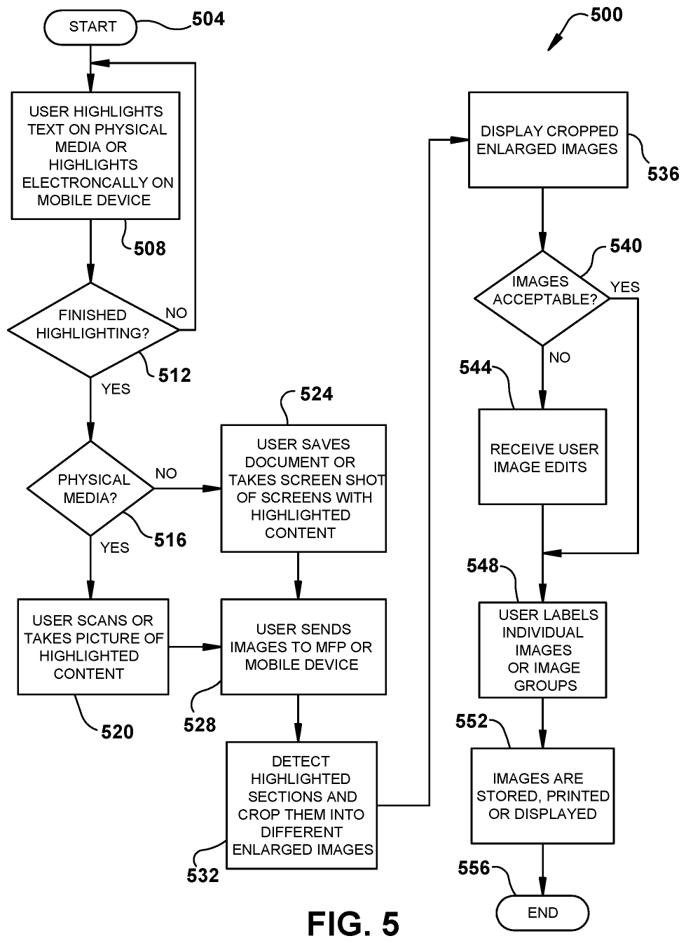

FIG. 5 is a flowchart of an example embodiment of an automated study card generation system 500. The process commences at block 504 and proceeds to block 508 where a user highlights document portions such as text areas on physical media, such as paper or electronic media using a digital device. The process continues until highlighting is competed as determined at block 512. Next, if physical media is used as determined at block 516, a digitized copy is obtained by scanning or taking a digital picture at block 520. If not, at block 524 a highlighted digital page is sent, or a screenshot is sent. In either instance, the process moves to block 528 where captured images are sent for processing to an MFP or other device, such as a mobile device.

Next, highlighted portions are detected, cropped and enlarged at block 532 and the results displayed at block 536. The user determines whether the images are acceptable at block 540. Unacceptable images receive user edits at block 544. Acceptable or edited images are labeled and grouped at block 548 and stored, printed or displayed at block 552. Once stored, images may be retrieved for review, such as by searching by label name, group name, folder name or the like. The process suitably ends at block 556.

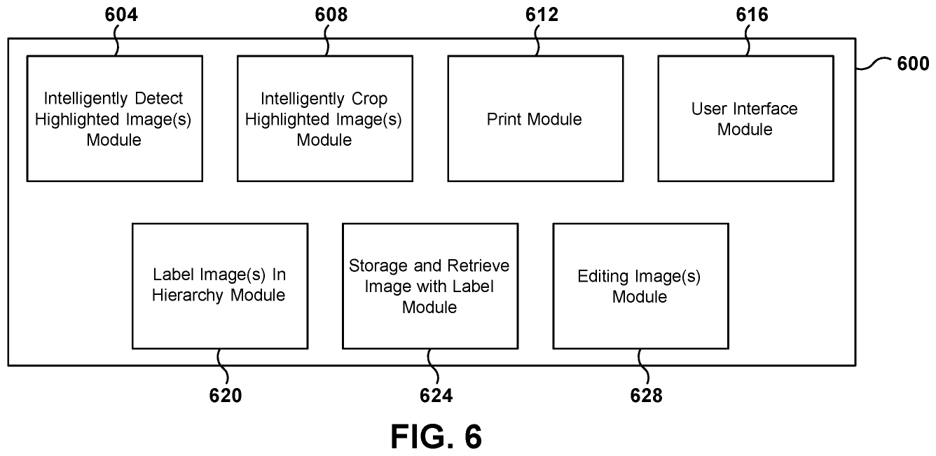

FIG. 6 illustrates an example embodiment of a software block diagram 600 suitably implemented in connection with an automated study card generation system as detailed above. Included are software module 604 for intelligent highlighted image detection, module 608 functioning to intelligently crop highlighted images, print module 612, user interface module 616, hierarchical labeling module 620, storage and retrieval of labeled study cards in module 624 and image editing module 628.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a user interface;
a processor;
memory storing image data having user highlighted image portions;
the processor configured to detect the user highlighted image portions of the image data;
the processor further configured to crop the user highlighted image portions into study card image data;
the processor further configured to assign one or more labels to cropped user highlighted image portions;
the processor further configured to generate one or more study card images, each study card image having one or more cropped user highlighted image portions and an associated user supplied label; and
the processor further configured to display study card images on the user interface.

2. The system of claim 1 wherein the image data is generated from user input received via the user interface on a displayed document image.

3. The system of claim 1 wherein the image data is received from a captured document image.

4. The system of claim 3 further comprising a digital camera or scanner configured to capture the captured document image.

5. The system of claim 2 wherein the processor is further configured to show the study card images on a display of the user interface.

6. The system of claim 5 wherein the processor is further configured to receive the user supplied label from an associated user via the user interface responsive to a displayed study card image.

7. The system of claim 6 wherein the processor is further configured to receive labels for user selected groups of study card images.

8. The system of claim 7 wherein the processor is further configured to receive user edits to the study card images in accordance with input received via the user interface.

9. A method comprising:
storing, in memory, image data having user highlighted image portions;
detecting, via a processor, the user highlighted image portions of the image data;
cropping the user highlighted image portions into study card image data;
assigning one or more labels to cropped user highlighted image portions;
generating one or more study card images, each study card image having one or more cropped user highlighted image portions and an associated user supplied label; and
displaying study card images on a user interface display.

10. The method of claim 9 further comprising generating the image data from user input received via a user input of the user interface on a displayed document image.

11. The method of claim 9 further comprising capturing the image data from a tangible document.

12. The method of claim 11 further comprising capturing the image data via a scanner or mobile device camera.

13. The method of claim 10 further comprising displaying the study card images on a display of the user interface.

14. The method of claim 13 further comprising receiving the user supplied label from an associated user via the user interface responsive to a displayed study card image.

15. The method of claim 14 further comprising receiving labels for user selected groups of study card images.

16. The method of claim 15 further comprising receiving user edits to the study card images in accordance with input received via the user interface.

17. A method comprising:
highlighting selected portions of a document;
storing a digitized image of a highlighted document;
detecting highlighted portions of a stored digitized image of the document;
extracting detected highlighted portions from the digitized image;
displaying extracted, detected highlighted portions on a display; and
assigning one or more displayed images into one or more groups.

18. The method of claim 17 further comprising:
highlighting the selected portions with a highlighting pen applied to a tangible document; and
capturing a digitized image of a highlighted tangible document to form the stored digitized image.

19. The method of claim 17 further comprising:
displaying the document on the display;
receiving the highlighting on the displayed document via a user interface; and
generating the stored digitized image in accordance with received highlighting.

20. The method of claim 17 further comprising:
receiving one or more group labels from an associated user via a user interface; and
assigning the one or more displayed images into labeled groups in accordance with user input received via the user interface.
